(19) United States
(12) Patent Application Publication
(10) Pub. No.: US 2014/0337222 A1
(43) Pub. Date: Nov. 13, 2014

(54) DEVICES AND METHODS PROVIDING MOBILE AUTHENTICATION OPTIONS FOR BROKERED EXPEDITED CHECKOUT

(71) Applicants: Ayodele Damola, Solna (SE); Luis Barriga, Bandhagen (SE); Rickard Damm, Nacka (SE)

(72) Inventors: Ayodele Damola, Solna (SE); Luis Barriga, Bandhagen (SE); Rickard Damm, Nacka (SE)

(73) Assignee: Telefonaktiebolaget L M Ericsson (publ), Stockholm (SE)

(21) Appl. No.: 14/232,466

(22) PCT Filed: Nov. 14, 2011
(86) PCT No.: PCT/IB2011/002689

§ 371 Date: Jul. 31, 2014

Related U.S. Application Data
(60) Provisional application No. 61/507,900, filed on Jul. 14, 2011.

(51) Int. Cl. G06Q 20/32; G06Q 20/38

(52) U.S. Cl. CPC G06Q 20/322; G06Q 20/3821
USPC 705/44

(57) ABSTRACT

Apparatuses and methods for brokered expedited checkout for e-shopping in telecommunication networks are provided. An apparatus is configured to facilitate checkout for a purchase by a user using user equipment from an e-shop in a telecommunication network. The apparatus has a processing unit configured to authorize the user, to access information related to the user, to respond to queries related to the user based on the information, and to mediate between a payment system and the e-shop in order to pay for the purchase.

### RELATED APPLICATION

This application is related to, and claims priority from, U.S. Provisional Patent Application Ser. No. 61/507,900 entitled “Devices and Methods Providing Mobile Authentication Options for Brokered Expedited Checkout”, Filed on Jul. 14, 2011.

### TECHNICAL FIELD

The present invention generally relates to devices, software and methods performed in a telecommunication network enabling an expedited checkout based on prior mobile subscription.

### BACKGROUND

Connected mobile or fixed user equipment (UEs) is capable to present multimedia content from various sources and corresponding to various application sessions to users. A variety of hardware and software generically named mobile cloud accelerator (MCA) concur in making possible UEs (e.g. phones, tablets, personal computers) to operate as promptly, efficiently and seamlessly as possible.

E-commerce over the Internet using web technologies is well established and increases continuously. In order to purchase goods and/or services via a network using UEs, users operate the UE to select items based on the presented content received from e-shops connected to the network. The selected items are placed into a so called (virtual) basket. A checkout process is also completed via the network, the UE and the e-shops interacting with equipment connected to the network that is used by financial institutions to provide payment services. During this checkout process the user is asked to provide personal information such as name, home/delivery address and then securely paying using some payment instrument such a credit card, a bank account or an e-Wallet. The payment mechanism often involves user authorization that in turn requires a separate user authentication in order to prevent fraud.

A conventional e-commerce system 1 over Internet is illustrated in FIG. 1. In the system 1, the user equipment (UE) 10, the e-shop 20, mobile network operator equipment 30, and the equipment of the financial institution 40—communicate one-to-one via Internet. The conventional systems (such as 1) have disadvantages affecting buyers, mobile network operators that provide network services and e-shop providers.

In the context of rising use of mobile terminals in the mobile networks for shopping and other transactions, providing checkout information may be tedious. It has been observed that over 30% of potential buyers quit purchase transactions during checkout due to the hassle with providing multiple items of information (name address and credit card details) on the merchant's website. Another source of dropout comes from unexpected external events that interrupt the ongoing purchases forcing the user to start again or later on. Therefore, it would be beneficial to simplify the checkout process such as to require the user to input less or at least less frequently information, while still ensuring security/privacy relative to the user's information and an overall transaction security.

Several Mobile Network Operators (MNOs) via corresponding equipments connected to network are taking the payment provider role based on user e-Wallet. In other words, the user pays for the purchase based on the service agreement with the MNO (e.g., on the same phone bill or as a separate wallet bill). In order to reach as many e-Shops providers as possible, each MNO needs to sign Service Level Agreements (SLAs) with each e-Shop provider. This approach doesn't scale and there is a need for a simpler SLA model enabling scalability. Also, MNOs expose user e-Wallet and user databases in their equipments, to other equipments in the network, in order to enable payments. This exposure implies opening access via the network to plural e-shops resulting in an increased risk for hacker attacks. Therefore, finding a solution that reduces MNO equipment exposure would be beneficial.

As in the case of MNOs, in order to reach as many mobile shoppers having different MNOs, e-Shop providers need to sign SLAs with each MNO to allow the usage of MNO e-Wallets. Additionally, financial institutions providing credit card services need to sign SLAs with each e-Shop provider. Such an approach doesn't scale and there is a need simpler SLA model enabling scalability. Also, e-Shops would need to connect to each MNO e-wallet where there is a plethora of different technologies creating an integration barrier to the e-Shops.

In several countries, usage of Internet and mobile phone is ahead of availability of e-payment systems thereby preventing potential e-shoppers from shopping via Internet. Therefore, there is a need for an e-Wallet service that is quickly deployable preferably using available operator assets.

For any actor in a purchase transaction handling credit card information and/or eWallet information, regulatory compliance (such as PCI-DSS) is required. Meeting this requirement causes a high investment cost due to strict requirements on physical and IT security, personnel control and audits. Therefore, there is a need to off-load e-Shops from such high barrier while still keeping regulatory compliance to the overall solution.

Accordingly, it would be desirable to provide devices, software and methods located in, performed by or related to a mobile cloud accelerator (MCA) of a mobile network, that provide pathways for an expedited checkout based on prior mobile authentication.

### SUMMARY

Apparatuses and methods according to various embodiments streamline a checkout process for e-shopping over a telecommunication network (i.e., mobile networks or Internet). The apparatuses intermediate between users using user equipment connected to the network, mobile network provider equipment, e-shops, and network equipment of financial institution. The use of these apparatuses eliminates the need for multiple level agreements between mobile network providers and shops due to the brokering/aggregation role of the apparatus. Different authentication methods may be used in conjunction with the apparatus allowing also adaptation relative to purchase limits, security levels and user convenience. The e-shops and equipments of the financial institution do no longer have each to comply with the regulated security level, the adequate level being ensured by apparatus' use of tokenization.

According to an exemplary embodiment an apparatus configured to facilitate checkout for a purchase by a user using a user equipment, from an e-shop via a telecommunication network is provided. The apparatus includes a processing unit configured (1) to authorize the user, (2) to access information related to the user, (3) to respond to queries related to the user based on the information, and (4) to mediate between a payment system and the e-shop in order to pay for the purchase.

According to another exemplary embodiment, a brokered expedited checkout method performed in a telecommunication network and related to a purchase by a user using user equipment from an e-shop connected via the telecommunication network is provided. The method includes (A) pre-identifying the user under different registered mobile identifiers, using the user equipment, (B) authenticating the user under any of the different registered mobile identifiers, (C) authorizing the authenticated user to make the purchase, (D) providing purchase-related user information for the purchase based on information acquired from one or more sources under user authorization, and (E) mediating between a payment system and the e-shop in order to pay for the purchase.

According to another exemplary embodiment, a computer readable medium storing executable codes which when executed in one or more nodes of a communication network coordinated as a mobile cloud accelerator, make the one or more nodes to execute a brokered expedited checkout method is provided. The method includes (A) pre-identifying the user under different registered mobile identifiers, using the user equipment, (B) authenticating the user under any of the different registered mobile identifiers, (C) authorizing the authenticated user to make the purchase, (D) providing purchase-related user information for the purchase based on information acquired from one or more sources under user authorization, and (E) mediating between a payment system and the e-shop in order to pay for the purchase.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a conventional e-commerce system;

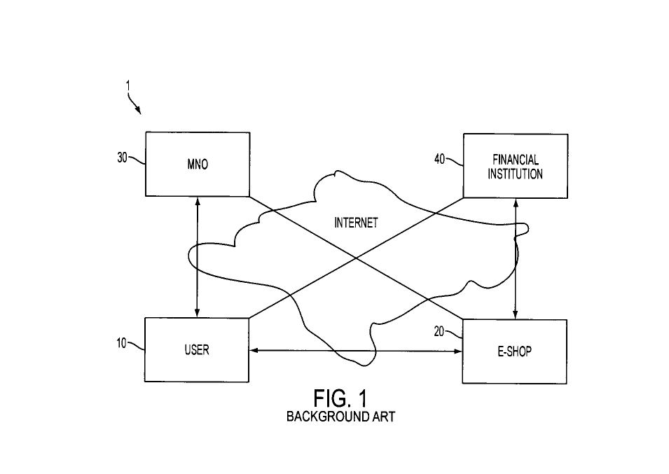

FIG. 2 is schematic diagram an e-commerce system according to an exemplary embodiment;

FIG. 3 is a generic illustration of operative flows between actors in an e-commerce system according to an exemplary embodiment;

FIG. 4 illustrates various authentication methods useable in embodiments;

FIG. 5 is an illustration of a user interface that may be provided by an e-shop to be presented by a user equipment to a user according to an exemplary embodiment;

FIG. 6 is a schematic representation of an e-commerce system using MSISDN and a static pin as authentication method, according to an exemplary embodiment;

FIG. 7 is a schematic diagram of an e-commerce system using an SMS password as authentication method, according to an exemplary embodiment;

FIG. 8 is a schematic diagram of an e-commerce system using GBA/GAA authentication method, according to an exemplary embodiment;

FIG. 9 illustrates a window displayed at the user equipment, according to an exemplary embodiment;

FIG. 10 illustrates a system architecture and communications between components, according to an exemplary embodiments;

FIG. 11 illustrates exemplary embodiments of centrally deployed brokered expedited checkout outside MCA but configured to achieve discovering the corresponding MCA service point by querying the MNO of an authenticated user. Local discovery using pre-provisioned service points are also possible but not illustrated; and

FIG. 12 is a flow diagram of a brokered expedited checkout method performed in a telecommunication network and related to a purchase by a user using user equipment from an e-shop connected via the telecommunication network, according to an exemplary embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of an e-commerce system in which actors communicate via a telecommunication network. However, the embodiments to be discussed next are not limited to these e-commerce systems but may be applied to other multi-actor network intermediated systems.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification is not necessarily all referring to the same embodiment. Further, the particular features, structures or characteristics may be combined in any suitable manner in one or more embodiments.

The current inventive concept may be embodied in devices, methods or software that expedite a checkout process by detecting and auto-filling checkout information, based on prior authentication or pre-identification of the user. The user experience is enhanced by utilizing mobile network operator's assets (information) to ease the burden during checkout.

Some of the abbreviations used in this document are explained in the list below and are known to a person of skilled in the art, for example, from current versions of the 3GPP documentation.

### BSF—Bootstrapping Server Function

### ES—Edge Server

### GBA—Generic Boostrapping Architecture

### GGSN—Gateway GPRS Support Node

### HLR—Home Location Register

### HSS—Home Subscriber Server

### MBB—Mobile Broadband

### MCA—Mobile Cloud Accelerator

### MES—Mobile Edge Server

### MSISDN—Mobile Station Integrated Services Data Network

### NAF—Network Application Function

### PCI-DSS—Payment Card Industry Data Security Standards

### SIM—Subscriber Identity Module

### SMS—Short Message Service

### SPC—Smart Pipe Controller

### TLS—Transport Layer Security

### WiFi—Wireless Fidelity (WLAN)

### XCO—Expedited Checkout

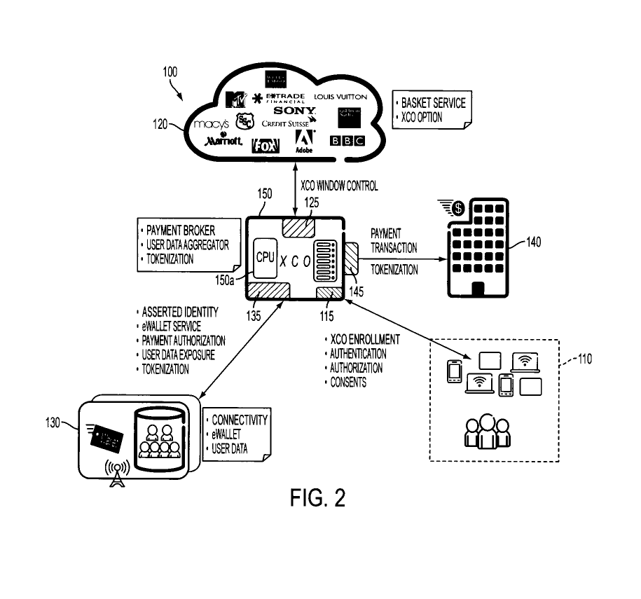

FIG. 2 is schematic diagram an e-commerce system 100 according to an exemplary embodiment. The system 100 includes plural equipments connected in a telecommunication network. Stores have network interfaces known as e-shops 120 that are configured to facilitate purchase of their products by users such as a user operating user equipment 110. A network service provider, also known as Mobile Network Operator, connects equipment 130 to provide a network connectivity service to the user using the user equipment 110. Financial institutions 140 providing financial services such as (but not limited to) credit cards, also have equipment 140 connected to the telecommunication network for providing payment services to users such as the user of the user equipment (UE) 130. For simplifying the following description without loss of generality, the equipment 130 of the Mobile Network Operator is called MNO.

An apparatus 150 called Expedite Checkout (XCO) broker-aggregator that is connected in the network to the UE 110, the MNO 130 and the e-Shops 120. XCO 150 operates to expedite the purchase checkout process by pre-identifying the user, authenticating the user, auto-filling personal payment information and brokering payments using existing payment systems.

Existence of the apparatus 150 simplifies the SLA model, both the mobile network operators and the stores becoming able to offer their services to users connected via UEs to the network, upon signing only one SLA with the entity owning the XCO 150. Optionally, the entity owning the XCO 150 can also sign SLAs with financial institutions and act as a payment broker towards banks, credit card companies and payment providers.

Further, the use of XCO 150 may provide payment brokering using an XCO service and infrastructure that off-load e-shops from integration with multiple complex payment systems, by a single integration with the XCO using secure web-technologies. XCO interworks with payment systems at mobile operators and with financial institutions.

Moreover, the use of XCO 150 may provide user authentication and data aggregation using an XCO service and infrastructure that integrates with mobile network operators' equipment, core network and user databases so that authentication information can be used for payments.

The XCO 150 may include a processing unit 150a and various interfaces specialized for interacting with other equipments in the e-commerce system 100: a first interface 115 configured to enable communication of the processing unit 150a with the user equipment 110, a second interface 135 configured to enable communication of the processing unit 150a with the MNO 130, a third interface 125 configured to enable communication of the processing unit 150a with the e-shops 120, and a fourth interface 145 configured to enable communication of the processing unit 150a with equipment 140 of payment providers (i.e., financial institutions).

The XCO 150 may mediate a tokenization process between the user using the user's eWallet in MNO 130, user equipment 110 and equipment 140 of the financial institutions during online transactions. Alternatively, XCO 150 may mediate a tokenization process between the user equipment 110 and the eWallet in MNO equipment 130 during eWallet provisioning.

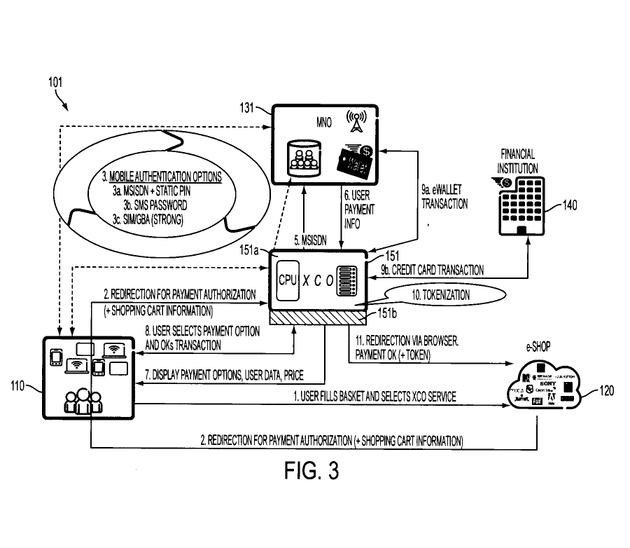

A generic description of operative data flows between equipments in an e-commerce system 101 according to an exemplary embodiment is illustrated in FIG. 3. First, at “1”, a user using a user equipment (UE) 110 initiate a purchase by selecting products or services offered by a store via an e-shop 120. In other words, the user fills a virtual basket. When at “2”, the user using UE 110 then indicates the intent to use the XCO 151, from the e-shop 120 payment authorization and the shopping cart information is redirected towards the XCO 151. The user using the user equipment 110 may be authenticated at “3” using any one of plural available methods. The available authentication methods may include an asserted identity method, such as, mobile identity method such as MSISDN, a password-based method, a messaging-based password method, such as, SMS, and a GBA/GAA method.

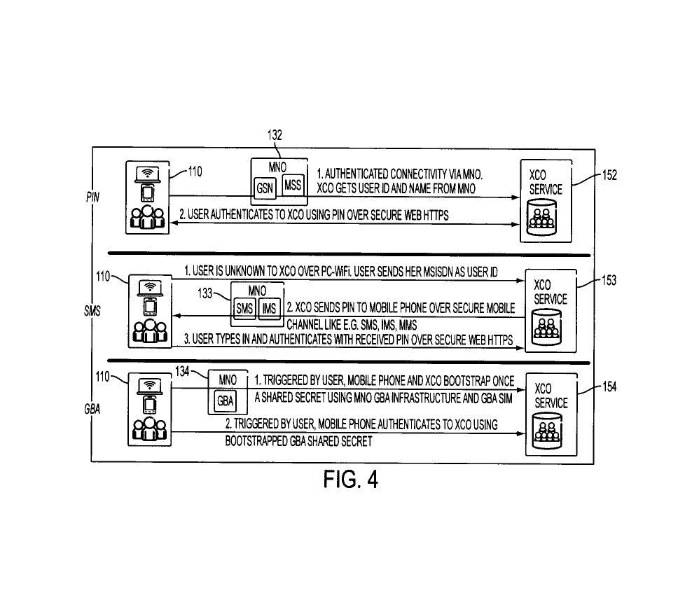

In authentication phase, the UE, MSN and XCO interact as illustrated in FIG. 4. The upper portion of FIG. 4 illustrates an MSISDN method with static pin. The MNO 132 and the XCO 152 are configured to perform this authentication method during which, based on a pre-authenticated connectivity via MNO 132, XCO 152 receives user ID and name from MNO 132, at “1”. Then, the user authenticates to XCO 152 using a PIN over secure web HTTPS, at “2.”

The middle portion of FIG. 4 illustrates and the SMS authentication method. The user using UE 110, who is unknown to XCO 153 over PC-WiFi, send MSISDN as user ID, at “1”. The XCO 153 sends PIN to mobile phone over secure mobile channel, such as, SMS, IMS, MMS, via MNO 133, at “2”. Then, the user provides via UE 110 the PIN to the XCO 153 over secure web HTTPS, at “3.”

The bottom portion of FIG. 4 illustrates the GBA authentication method. In this methods, triggered by user, the mobile phone and XCO 154 bootstrap once a shared secret using MNO GBA infrastructure of MNO 134 and GBA SIM card in the mobile phone (i.e., UE 110), at “1”. Then, triggered by user, mobile phone 110 authenticates to XCO 154 using bootstrapped GBA shared secret.

The MNO 132, 133, 134 may be the same equipment. Similarly the XCO 152, 153, 154 may be the same equipment.

In a system such as 101 in FIG. 3, XCO 151 communicates with user equipment UE 110 to achieve user enrolment to the XCO service and for performing the XCO service itself. The XCO 151 includes a CPU 151a including a processor and capable to be programmed to provide the XCO functionality. Executable codes implementing this functionality (i.e., which when executed by the CPU 151a provide the asserted functionality) may be stored in a memory 151b.

The XCO's CPU 151a may be configured to execute a user authentication function prior to authorization and user data exposure. The XCO's CPU 151a may further be configured to execute a user payment authorization function as requested by the e-shop. The XCO's CPU 151a may also be configured to execute a user data auto-filling. The XCO's CPU 151a may also perform tokenization to protect credit card and e-Wallet information. The e-Wallet may be related to the MNO 131 or to the XCO 151 itself.

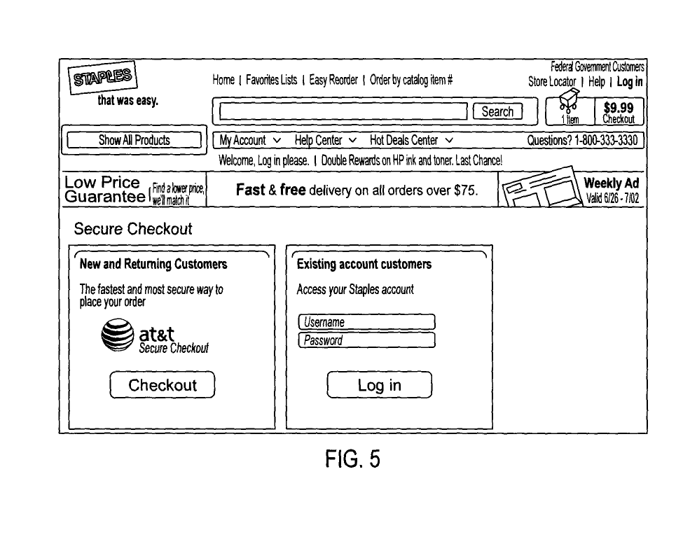

FIG. 5 is an illustration of a user interface that may be provided by the e-shop to be presented by the user equipment to the user. On this display a “Checkout” button for expedited checkout according to various embodiments described above is provided.

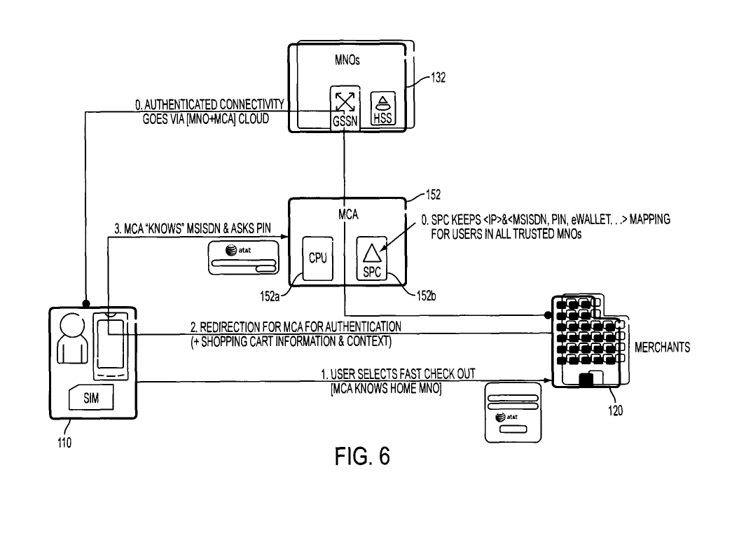

FIG. 6 is a schematic representation of an e-commerce system using MSISDN and a static pin as authentication method.

The MCA is from the connectivity point of view at a crossroad between users, mobile network operators (MNOs) and merchants. The home operator and user identity are auto-detected by MCA. For example, the MCA may detect the phone number of the mobile phone used in the transaction. The authentication is based on the user's identity (i.e., an implicit SIM network authentication) and a static pin input by the user via the mobile terminal (e.g., the mobile phone). According to this option, the authentication process uses the mobile broadband (MBB) and the MCA.

For a given transaction (e.g., purchase), the user profile may be auto-filled by MCA using internal and external information.

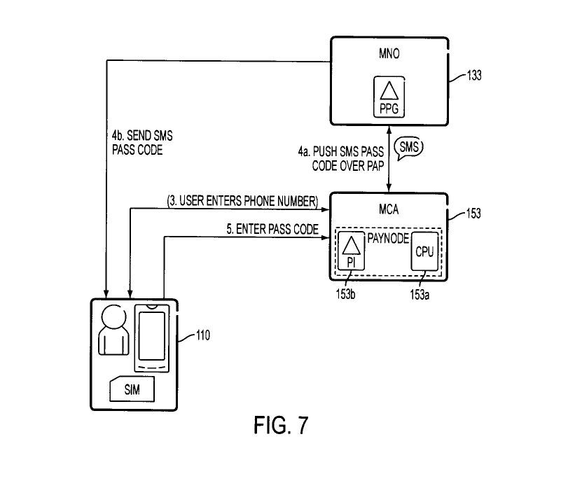

FIG. 7 is a schematic diagram of an e-commerce system using an SMS password as authentication method. The user's explicit authentication is performed over the WiFi and involves the mobile network operator which provides to the user and the MCA an SMS pass code used for a handshake at 5. The user provides the hope operator and user's identity only once during a usage period that may include plural transactions. Cookies auto-fill afterwards. After authentication, MCA fills the user profile for ongoing transactions.

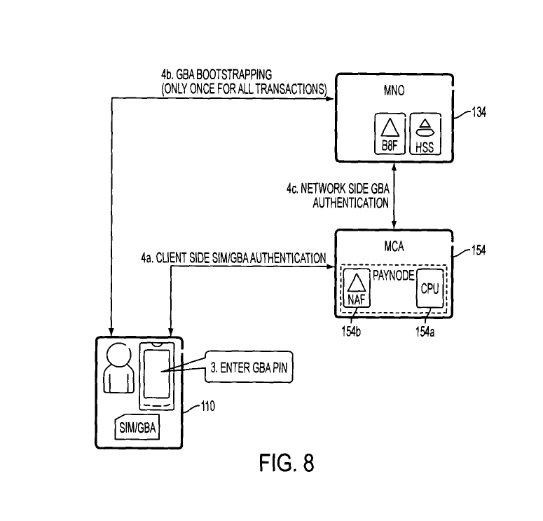

FIG. 8 a schematic diagram of an e-commerce system using GBA/GAA authentication method. This method (when available) is the most secure among the authentication options supported by MNOs. The MNO and user identity are auto-detected by MCA. A shared secret key is provided by the MNO to both the user GBA equipment 110 and the MCA 154b. To authorize th usage of GBA the user only needs to use locally within 110 a static GBA PIN.

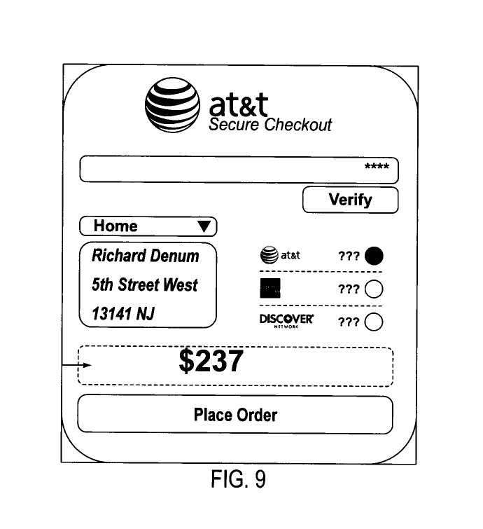

FIG. 9 illustrates a window displayed at the user equipment. The window has information items auto-filled with user information and payment options. A default option is made available to thus provide to the user possibility to complete the purchase with a minimal intervention (e.g., only a confirmation). If the value of the transaction exceeds a predetermined value (e.g., $200), authentication using most secure method may be required.

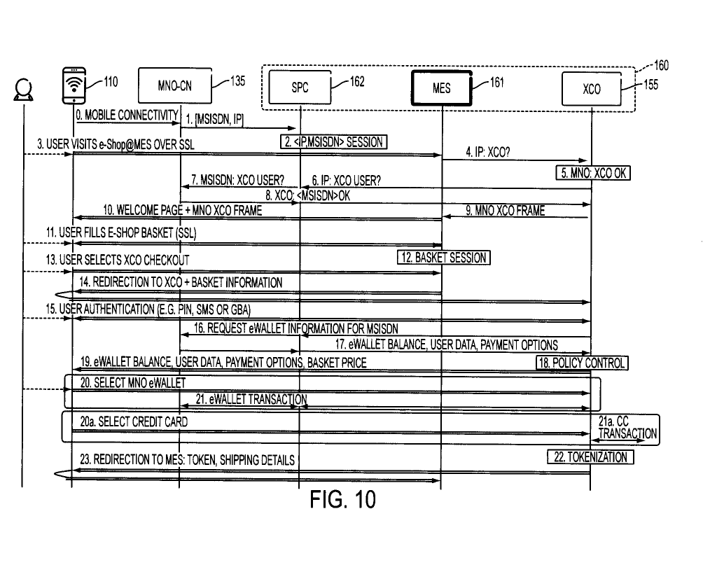

FIG. 10 illustrates a system architecture in which a Mobile Cloud Accelerator (MCA) is assumed to be deployed very close to the MNO's core network (MNO-CN) 135. In such a scenario, the XCO 155 can be co-located with the MCA and exploit the proximity of the MCA to MNO-CN 135 in order to streamline the integration with the MNO-CN 135 and thus obtain the necessary subscriber information for auto-filling payment forms. The MCA local site 160 (inside the dashed contour) may include Smart Pipe Controller (SPC) 162, Mobile Edge Server (MES) 161 and the XCO 155. The SPC 162 handles the interface to the MNO-CN 135. If the XCO is co-located with the MNO, the MNO user can then reach the e-shop that is implemented in the MES 161.

In such a system, according to an exemplary embodiment, the following sequence of operations occurs:
0 the UE attaches to the network
1 the MNO-CN passes the mapping of the MSISDN to the current IP assigned to the UE
2 the SPC stores the MSISDN to IP mapping in a local session database
3 user browses to the e-shop portal whose content is at the MES
4 the MES needs to checks if this session should be handled by XCO
5 XCO check if the MNO is in the XCO circle (SLA signed) and then proceeds to handle the session from this IP address
6 XCO requests the SPC to check if the user behind this IP address has signed for XCO service
7 The SPC forwards the request to the MNO-CN after converting to MSISDN
8 The MNO finds the user is an XCO user and returns OK. The SPC forwards the OK adding the MSISDN
9 XCO supplies the MNO with a filled XCO frame according to agreement with XCO
10 Now the MES (content provider) can render the complete web page in its portal where the MNO XCO frame will be visible to the user
11 If the same user already had a previous purchase session under a different mobile identifier, that session is resumed if the user is wishes so. Otherwise, the user starts a new purchase session and selects items for purchase into the e-shop basket
12 basket session information stored
13 user click on the XCO checkout button mentioned in step 10
14 the MES redirects the request to the XCO service for checkout along with the contents of the basket to the XCO function and payment policies, e.g. age control, that the XCO must enforce
15 the user is authenticated by providing the PIN code or any other authentication mechanism mentioned previously
16 after successful authentication the XCO requests for the eWallet information from the MNO including user payment data
17 MNO returns eWallet information and user personal data needed for payments
18 The XCO enforces some policy control checking according to SLA, for example age control for purchase, eWallet or credit card limitations.
19 the eWallet information is used to populate the web page presented to the user including the balance, user data, payment options and basket price From here the user may select either to pay from eWallet or from credit card
20 (20a) user selects eWallet as payment option. (User selects credit card)
21 (21a) eWallet transaction is performed. (credit card transaction performed)
22 After a successful transaction either via eWallet or credit card, tokenization is applied to the information to be returned to the MES. Tokenization protects the eWallet or credit card information respectively.
23 The user browser is redirected to the XCO with authorization token and other additional information such as shipping details.

According to some embodiments, a user can be connected to an e-shop over the Internet (e.g. at an Internet café or at home over Wi-Fi/LAN) and still use the XCO. The XCO is outside the MCA to be reachable over Internet. The contacted edge server ES needs to discover which SPC MCA to talk to and a mechanism is need to discover that service point and the rest of the flows would follow the same procedures as in the previous section.

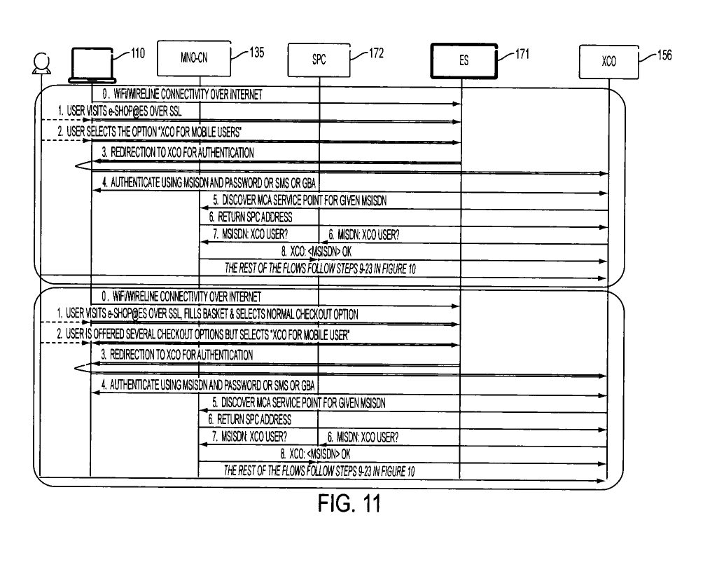

FIG. 11 illustrates embodiments configured to achieve discovering the service point. The difference between top and bottom of FIG. 11 is when the user is actually authenticated. In the top portion, the user is identified and authenticated prior to start filling the basket. In the bottom portion the user is authenticated after the basket is filled. In both cases the discovery process occurs at steps 5-6, whereby the XCO 156 contacts the MNO 135 providing the MSISDN of the authenticated user, and the MNO 135 replies with the address of the service point where further XCO 156 related queries can be done.

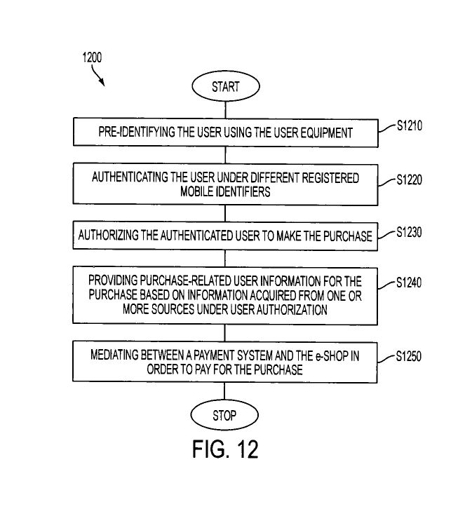

A flow diagram of a brokered expedited checkout method (1200) performed in a telecommunication network and related to a purchase by a user using user equipment from an e-shop connected via the telecommunication network is illustrated in FIG. 12. The method 1200 includes pre-identifying the user under different registered mobile identifiers, using the user-equipment at S1210, authenticating the user under any of the different registered mobile identifiers at S1220, authorizing the authenticated user to make the purchase at S1230, providing purchase-related user information for the purchase based on information acquired from one or more sources under user authorization, at S1240, and mediating between a payment system and the e-shop in order to pay for the purchase, at S1250.

Method 1200 may further include registering the user including authenticating the mobile user and acquiring the information related to the user for payment purposes. The user registration may include more than one MSISDNs used by the same user/subscriber across a plurality of connected devices where the same XCO service would be offered for said user/subscriber. The authenticating of the user may be performed using one of a plurality of authentication methods including a mobile identity method with password-based, a secure messaging-based password method, and a GBA/GAA method.

Method 1200 may also include requiring the user to be authenticated using the GBA/GAA method, if a payment for the purchase exceeds a predetermined payment threshold. The payment system may be an e-wallet corresponding to the user. The method may be performed by one or more nodes of the communication network coordinated by a mobile cloud accelerator.

The method 1200 may further include displaying a window at the user equipment for initiating an expedited checkout. The window may include a checkout button. The method 1200 may also include displaying a confirmation window including responses to the queries and details of the purchase at the user equipment. The confirmation window may be associated with functions enabling updating the responses to the queries, selecting one of a plurality of available payment systems to pay for the purchase, and a confirmation button.

In some embodiments, the mediation may include using tokenization for interacting with the payment system and/or with the user during on-line transactions. Alternatively, the tokenization can be done during eWallet provisioning by hiding full credit card information or any other sensitive date stored in the eWallet.

It should be understood that the above description is not intended to limit the invention. On the contrary, the exemplary embodiments are intended to cover alternatives, modifications and equivalents, which are included in the spirit and scope of the invention. Further, in the detailed description of the exemplary embodiments, numerous specific details are set forth in order to provide a comprehensive understanding of the inventive concept. However, one skilled in the art would understand that various embodiments may be practiced without such specific details.

The exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer readable medium may be utilized including hard disks, CD-ROMs, digital versatile disc (DVD), optical storage devices, or magnetic storage devices such a floppy disk or magnetic tape. Other non-limiting examples of computer readable media include flash-type memories or other known memories.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a specifically programmed computer or processor.

1. An apparatus configured to facilitate checkout for a purchase by a user using a user equipment from an e-shop in a telecommunication network, the apparatus comprising:
a processing unit configured
to authorize the user,
to access information related to the user,
to respond to queries related to the user based on the information, and
to mediate between a payment system and the e-shop in order to pay for the purchase.

2. The apparatus of claim 1, further comprising:
a first interface configured to enable communication of the processing unit with the user equipment;
a second interface configured to enable communication of the processing unit with a mobile network operator (MNO);
a third interface configured to enable communication of the processing unit with the e-shop; and
a fourth interface with payment providers.

3. The apparatus of claim 2, wherein the processing unit is configured to register the user under one or more different mobile identifiers by authenticating the user and acquiring the information related to the user.

4. The apparatus of claim 3, wherein the processing unit is configured to communicate with the MNO and the e-Shop based on an underlying user authentication as a pre-identification of the user under any of the registered mobile identifiers.

5. The apparatus of claim 3, wherein the processing unit is configured to communicate with the MNO and the mobile user during authentication of the mobile user.

6. The apparatus of claim 5, wherein the processing unit is configured to authenticate the mobile user using one of a plurality of mobile authentication methods including an asserted identity method, a password-based method, a messaging-based password method, and a GBA/GAA method, for any of the registered mobile identifiers.

7. The apparatus of claim 6, wherein the processing unit is configured to require the mobile user to be authenticated using the GBA/GAA method, if a payment for the purchase exceeds a predetermined payment threshold.

8. The apparatus of claim 2, wherein the payment system is an e-wallet corresponding to the user.

9. The apparatus of claim 1, wherein the processing unit is configured to use tokenization when for interacting with the payment system or for establishing an e-wallet.

10. A brokered expedited checkout method performed in a telecommunication network and related to a purchase by a user using user equipment, from an e-shop connected via the telecommunication network, the method comprising:
pre-identifying the user under different registered mobile identifiers, using the user equipment;
authenticating the user under any of the different registered mobile identifiers;
authorizing the authenticated user to make the purchase;
providing purchase-related user information for the purchase based on information acquired from one or more sources under user authorization; and
mediating between a payment system and the e-shop in order to pay for the purchase.

11. The method of claim 10, further comprising registering the user including authenticating the user and acquiring the information related to the user for payment purposes.

12. The method of claim 11, wherein the authenticating of the user is performed using one of a plurality of authentication methods including a mobile identity method with password-based, a secure messaging-based password method, and a GBA/GAA method.

13. The method of claim 12, further comprising requiring the user to be authenticated using the GBA/GAA method, if a payment for the purchase exceeds a predetermined payment threshold.

14. The method of claim 10, wherein the payment system is an e-wallet corresponding to the user.

15. The method of claim 10, wherein the method is performed by one or more nodes of the communication network coordinated by a mobile cloud accelerator consisting of a Smart Pipe Controller for interfacing an MNO and a Mobile Edge Server that manages digital content of e-shops connected to the telecommunication network.

16. The method of claim 10, further comprising:
displaying a window at the user equipment for initiating an expedited checkout.

17. The method of claim 16, wherein the window includes a checkout button, the method further comprising:
displaying a confirmation window including responses to the queries and details of the purchase at the user equipment.

18. The method of claim 17, wherein the confirmation window is associated with functions enabling updating the responses to the queries, selecting one of a plurality of available payment systems to pay for the purchase, and a confirmation button.

19. The method of claim 10, wherein the mediating includes using tokenization for interacting with the payment system.

20. A computer readable medium storing executable codes which when executed in one or more nodes of a communication network coordinated as a mobile cloud accelerator, make the one or more nodes to execute a brokered expedited checkout method, the method comprising:
pre-identifying a user under different registered mobile identifiers, using a user equipment;
authenticating the user under any of the different registered mobile identifiers;
authorizing the authenticated user to make the purchase;
providing purchase-related user information for the purchase based on retrieved information from one or more sources under user authorization; and
mediating between a payment system and the e-shop in order to pay for the purchase.
